(19) United States
(12) Patent Application Publication
(10) Pub. No.: US 2014/0232351 A1
(43) Pub. Date: Aug. 21, 2014

(54) VOLTAGE MONITORING APPARATUS OF ASSEMBLED BATTERY

(71) Applicants: Yuichi Ikeda, Nagano (JP); Naoki Kitahara, Aichi (JP); Tomohiro Sawayanagi, Nagano (JP)

(72) Inventors: Yuichi Ikeda, Nagano (JP); Naoki Kitahara, Aichi (JP); Tomohiro Sawayanagi, Nagano (JP)

(73) Assignee: OMRON AUTOMOTIVE ELECTRONICS CO., LTD., Aichi (JP)

(21) Appl. No.: 14/181,351

(22) Filed: Feb. 14, 2014

(30) Foreign Application Priority Data
Feb. 15, 2013 (JP) 2013-027274

(51) Int. Cl. H02J 7/00

(52) U.S. Cl. CPC H02J 7/007
USPC 320/136

(57) ABSTRACT

A voltage monitoring apparatus of an assembled battery has a voltage monitoring section that monitors each voltage of the assembled battery formed by a plurality of cells, and a power supply circuit that acquires a voltage from the assembled battery to generate a power supply voltage of low voltage, and supplies the power supply voltage to a load. The assembled battery is configured by a series circuit of a first block, which includes a plurality of cells or a singular cell, and a second block, which is configured by a plurality of cells or a singular cell. The power supply circuit acquires a voltage from both ends of the second block. The voltage monitoring apparatus further has a power transmission circuit that acquires a voltage from both ends of the first block and supplies a power corresponding to the acquired voltage to at least the second block.

### BACKGROUND OF THE INVENTION

1. Technical Field

The present invention relates to an apparatus for monitoring the voltage of an assembled battery configured by a plurality of secondary cells.

2. Related Art

For example, a high voltage battery for driving a travelling motor and an in-vehicle device is mounted in an electric automobile. The high voltage battery is generally configured by a so-called assembled battery in which a plurality of secondary cells such as lithium ion cells are connected in series. In such assembled battery, a cell monitoring unit (CMU) for monitoring the voltage, the temperature, and the like of each cell is arranged to perform charging/discharging control of the cell (see Japanese Unexamined Patent Publication No. 2011-182550, Japanese Unexamined Patent Publication No. 2010-81692). A discharging circuit for correcting variation in voltage among the cells by preferentially discharging the cell of high voltage is arranged with respect to each cell configuring the assembled battery (see Japanese Unexamined Patent Publication No. 8-19188).

In the cell voltage monitoring apparatus of Japanese Unexamined Patent Publication No. 2011-182550, the cells configuring the assembled battery are grouped into a plurality of blocks, a monitor IC for detecting the voltage and current of each cell is arranged in correspondence with each block, and each monitor IC acquires an operation power supply from the block configured by the cells to be monitored.

In a vehicle power supply device of Japanese Unexamined Patent Publication No. 2010-81692, the travelling battery is divided to a plurality of cell blocks, a plurality of voltage detection circuits for detecting the voltage of the respective cell block are arranged, and each voltage detection circuit is operated with power supplied from the respective cell block.

In the assembled battery charging device of Japanese Unexamined Patent Publication No. 8-19188, the discharging circuit (by-pass circuit) including a switching element is connected in parallel to each cell of the assembled battery, and the discharging circuit is conducted to perform discharging with respect to the cell in which a voltage difference between the lowest voltage and the voltage of each other cell has exceeded a predetermined value of the voltages of each cell at the time of charging detected by the voltage detection unit.

In Japanese Unexamined Patent Publication No. 2011-182550, Japanese Unexamined Patent Publication No. 2010-81692, and Japanese Unexamined Patent Publication No. 8-19188, the voltage of each cell is detected by the voltage detection unit connected to the assembled battery. The power supply circuit for supplying power to the voltage detection unit acquires voltage from both ends of the assembled battery to be monitored. In this case, the voltage of both ends of the assembled battery is a high voltage, and hence the high voltage needs to be dropped to generate the power supply voltage of low voltage in the power supply circuit. Thus, a circuit such as a DC-DC converter, and the like for converting high voltage to low voltage is necessary, which complicates the configuration of the power supply circuit.

Thus, rather than acquiring the voltage from the entire assembled battery, consideration is made to acquire the voltage necessary for the power supply circuit from a part of the assembled battery. The input voltage of the power supply circuit thus lowers, whereby a complicated circuit such as the DC-DC converter, and the like becomes unnecessary.

However, when the voltage is acquired from a part of the assembled battery, the cell voltage lowers in the cell, which is the target of voltage acquisition, due to the power consumption by the power supply to the power supply circuit and the load compared to the cell, which is not the target of voltage acquisition. In other words, the voltage becomes non-uniform among the cells configuring the assembled battery.

### SUMMARY

According to one or more embodiments of the present invention, a monitoring apparatus of an assembled battery prevents the voltage from becoming non-uniform among the cells even when acquiring the voltage for power supply from a part of the assembled battery.

In accordance with one or more embodiments of the present invention, a voltage monitoring apparatus of an assembled battery includes a voltage monitoring section configured to monitor each voltage of a plurality of cells configuring an assembled battery; and a power supply circuit configured to acquire a voltage from the assembled battery to generate a power supply voltage of low voltage, and to supply the power supply voltage to a load. The assembled battery is configured by a series circuit of a first block, which includes a plurality of cells or a singular cell, and a second block, which is configured by a plurality of cells or a singular cell. The power supply circuit acquires a voltage from both ends of the second block. A power transmission circuit configured to acquire a voltage from both ends of the first block and supply a power corresponding to the acquired voltage to at least the second block is arranged.

Thus, the power supply circuit acquires voltage from the second block, which is a part of the assembled battery, so that the input voltage of the power supply circuit is a low voltage compared to the voltage of the entire assembled battery. Thus, a circuit such as a DC-DC converter and the like for converting high voltage to low voltage is not necessary, thus simplifying the configuration of the power supply circuit. The power transmission circuit for acquiring the voltage from the first block is arranged, and the power corresponding to the acquired voltage is returned to at least the second block so that the power of the second block consumed by the power supply circuit and the load is compensated. The voltage of each cell configuring the assembled battery is thus equalized, and the voltage can be suppressed from becoming non-uniform among the cells.

In one or more embodiments of the present invention, the power transmission circuit includes, for example, a transformer with a primary winding and a secondary winding, and a switching element connected in series with the primary winding; transmits the voltage acquired from both ends of the first block from the primary winding to the secondary winding by an ON/OFF operation of the switching element; and supplies a power output from the secondary winding to at least the second block.

In this case, the voltage monitoring section may include a first voltage detection circuit configured to detect a first voltage, which is the voltage of both ends of the first block, a second voltage detection circuit configured to detect a second voltage, which is the voltage of both ends of the second block, and a computation control circuit configured to generate a control signal for controlling the switching element based on a comparison result of the first voltage and the second voltage.

Furthermore, the voltage monitoring section may determine whether or not the first voltage is greater than the second voltage; perform the ON/OFF operation of the switching element according to the control signal if the first voltage is greater than the second voltage; and not perform the ON/OFF operation of the switching element if the first voltage is not greater than the second voltage.

In one or more embodiments of the present invention, a power transmission circuit including a capacitor, a first switch arranged on an input side of the capacitor, and a second switch arranged on an output side of the capacitor may be adopted in place of the power transmission circuit described above. The power transmission circuit charges the capacitor with the voltage acquired from both ends of the first block through the first switch when the second switch is turned OFF and the first switch is turned ON; outputs a power of the charged capacitor through the second switch when the first switch is turned OFF and the second switch is turned ON thereafter; and supplies the power output from the capacitor to at least the second block.

In this case, the voltage monitoring section may include a first voltage detection circuit configured to detect a first voltage, which is the voltage of both ends of the first block, a second voltage detection circuit configured to detect a second voltage, which is the voltage of both ends of the second block, and a computation control circuit configured to generate a first control signal for controlling the first switch and a second control signal for controlling the second switch based on a comparison result of the first voltage and the second voltage.

The voltage monitoring section may determine whether or not the first voltage is greater than the second voltage; turn ON the first switch and then turns OFF the first switch after a given time according to the first control signal, and turn OFF the second switch and then turns ON the second switch after a given time according to the second control signal if the first voltage is greater than the second voltage; and maintain the first switch and the second switch in an OFF state if the first voltage is not greater than the second voltage.

In one or more embodiments of the present invention, the power output from the power transmission circuit may be supplied to the entire assembled battery.

According to one or more embodiments of the present invention, the cell voltage can be suppressed from becoming non-uniform among the cells even when acquiring the voltage for power supply from a part of the assembled battery.

### BRIEF DESCRIPTION OF THE DRAWINGS

FIG. 1 is a block diagram showing a first embodiment of the present invention;

FIG. 2 is a diagram showing a specific example of a balancer circuit;

FIG. 3 is a diagram showing a specific example of a low voltage power supply circuit;

FIG. 4 is a diagram showing a specific example of a temperature measurement circuit;

FIG. 5 is a diagram showing a voltage acquiring route of the low voltage power supply circuit;

FIG. 6 is a diagram showing the voltage acquiring route of a power transmission circuit in the first embodiment;

FIG. 7 is a diagram showing a power supplying route of the power transmission circuit in the first embodiment;

FIG. 8 is a flowchart showing an operation of the first embodiment;

FIG. 9 is a block diagram showing a variant of the first embodiment;

FIG. 10 is a diagram showing the power supplying route of the power transmission circuit in FIG. 9;

FIG. 11 is a block diagram showing a second embodiment of the present invention;

FIG. 12 is a diagram showing a voltage acquiring route of a power transmission circuit in the second embodiment;

FIG. 13 is a diagram showing a power supplying route of the power transmission circuit in the second embodiment;

FIG. 14 is a flowchart showing an operation of the second embodiment;

FIG. 15 is a diagram showing a circuit state of when a capacitor is charged;

FIG. 16 is a diagram showing a circuit state of when the capacitor outputs power;

FIG. 17 is a block diagram showing a variant of the second embodiment; and

FIG. 18 is a diagram showing the power supplying route of the power transmission circuit in FIG. 17.

### DETAILED DESCRIPTION

Embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Hereinafter, a case in which one or more embodiments the present invention is applied to an assembled battery mounted on an electric automobile will be described by way of example.

### First Embodiment

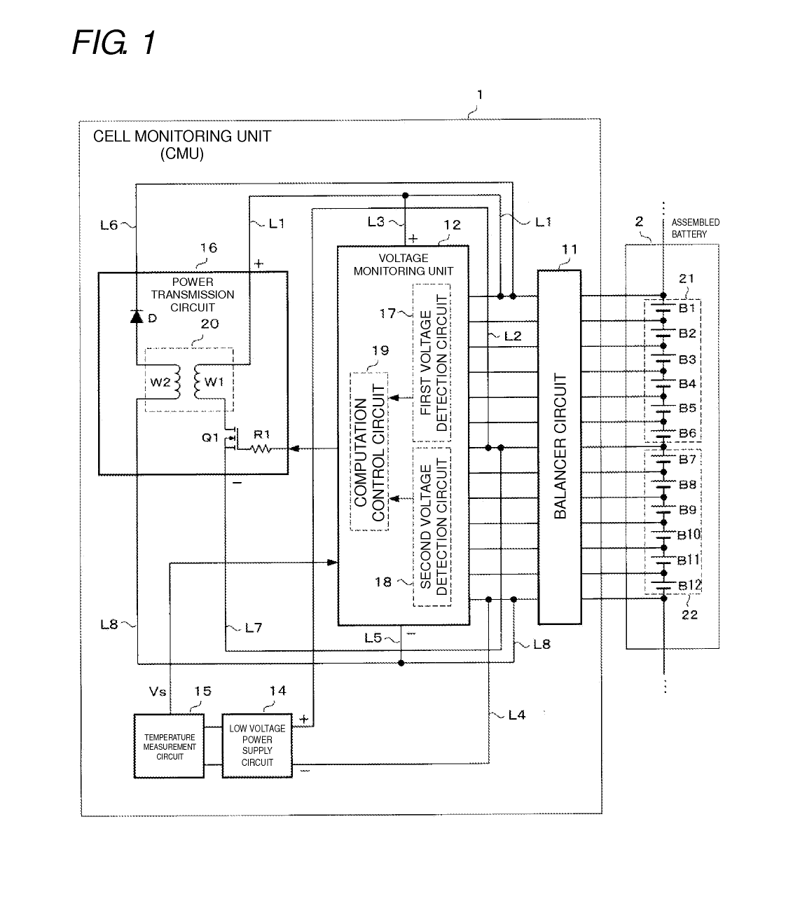

A first embodiment of the present invention will be described with reference to FIG. 1. In FIG. 1, an assembled battery 2 is configured by a plurality of cells B1 to B12 connected in series. The assembled battery 2 is a high voltage battery for driving a motor and an in-vehicle device of an electric automobile. Each of the cells B1 to B12 configuring the assembled battery 2 includes a secondary cell such as a lithium ion cell, lead storage cell, and the like, and is charged by a charging device (not shown). The cells B1 to B6 configure a first block 21, and the cells B7 to B12 configure a second block 22. Therefore, the assembled battery 2 is configured by a series circuit of the first block 21 and the second block 22.

A cell monitoring unit (CMU) 1 is a unit mounted on the vehicle to monitor the voltage, the temperature, and the like of the assembled battery 2. The cell monitoring unit 1 includes a balancer circuit 11, a voltage monitoring section 12, a low voltage power supply circuit 14, a temperature measurement circuit 15, and a power transmission circuit 16. Each of such elements is mounted on one circuit substrate. The cell monitoring unit 1 configures a voltage monitoring apparatus of an assembled battery according to one or more embodiments of the present invention.

The voltage monitoring section 12 includes a microcomputer, and monitors each voltage of the plurality of cells B1 to B12 configuring the assembled battery 2. Thus, the positive electrode and the negative electrode of each cell are connected to the voltage monitoring section 12 through the balancer circuit 11, to be described later. The voltage monitoring section 12 also monitors the total voltage of the entire assembled battery 2. Thus, the positive electrode of the cell B1 is connected to the voltage monitoring section 12 through the balancer circuit 11 and lines L1, L3, and the negative electrode of the cell B12 is connected to the voltage monitoring section 12 through the balancer circuit 11 and lines L8, L5.

The voltage monitoring section 12 includes a first voltage detection circuit 17, a second voltage detection circuit 18, and a computation control circuit 19. The first voltage detection circuit 17 detects a first voltage, which is a voltage of both ends of the first block 21 of the assembled battery 2. The second voltage detection circuit 18 detects a second voltage, which is a voltage of both ends of the second block 22 of the assembled battery 2. The computation control circuit 19 generates a control signal for controlling the ON/OFF operation of a switching element Q1 of the power transmission circuit 16 based on a comparison result of the first voltage and the second voltage (details will be described later). The voltage monitoring section 12 performs communication with a higher-order device (not shown).

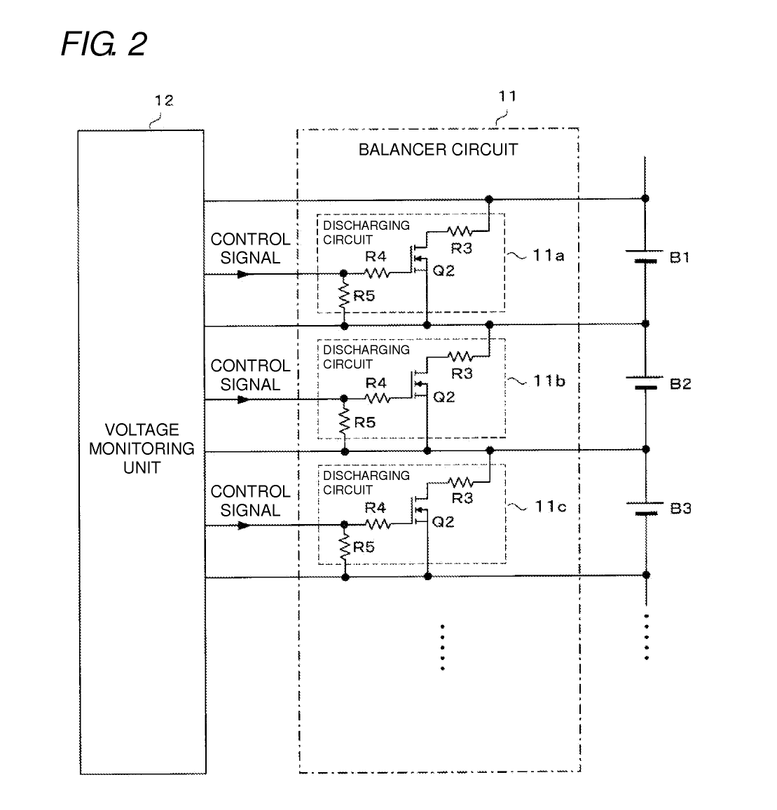

The balancer circuit 11 is a circuit for correcting the voltage non-uniformity among the cells caused by the variation in the discharging capacity of each of the cells B1 to B12 configuring the assembled battery 2. As shown in FIG. 2, the balancer circuit 11 is configured by a plurality of discharging circuits 11a, 11b, 11c, . . . arranged in correspondence with cells B1, B2, B3, . . . , respectively. The configuration of each discharging circuit is the same, and hence the discharging circuit 11a will be hereinafter described.

The discharging circuit 11a is a known circuit configured by a switching element Q2 and resistors R3 to R5. The switching element Q2 includes, for example, an FET (Field Effect Transistor). One end of the resistor R3 for discharging is connected to the drain of the switching element Q2, and the other end of the resistor R3 is connected to the positive electrode of the cell B1. The source of the switching element Q2 is connected to the negative electrode of the cell B1. A discharging path from the positive electrode of the cell B1 to the negative electrode of the cell B1 through the resistor R3 and the switching element Q2 is thereby formed. A control signal including a pulse signal is provided to the gate of the switching element Q2 from the voltage monitoring section 12 via the resistors R4, R5. The switching element Q2 performs the ON/OFF operation in accordance with the control signal. The details of the voltage uniformization by the discharging circuit 11a will be hereinafter described.

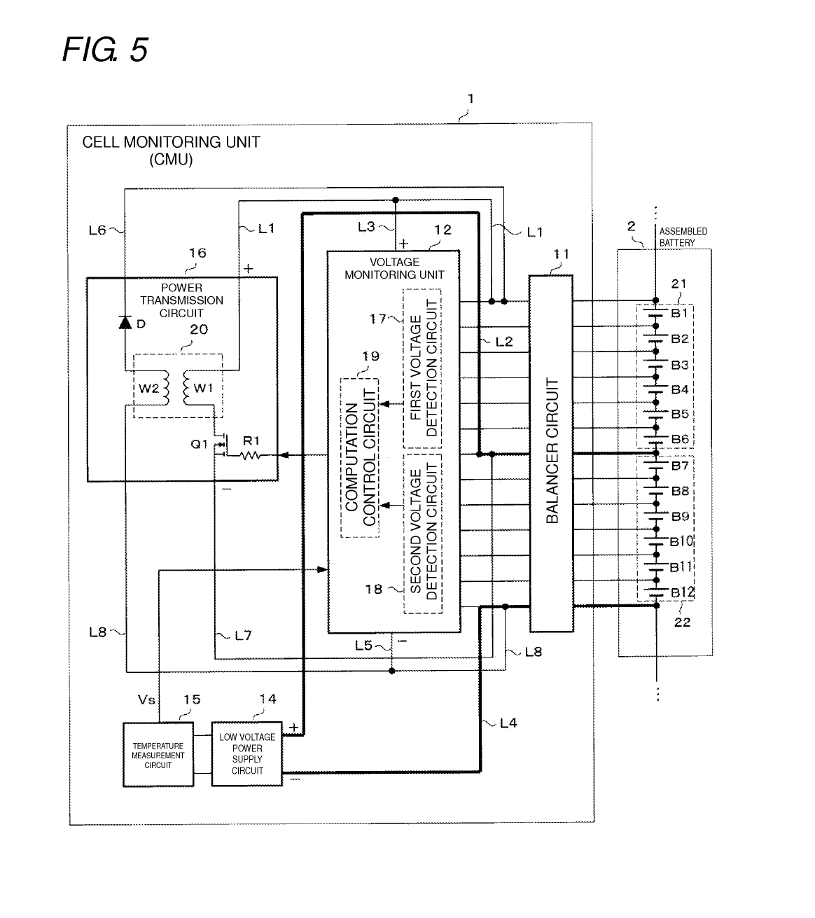

Returning back to FIG. 1, the low voltage power supply circuit 14 is a circuit for acquiring voltage from a part of the assembled battery 2 and outputting low voltage. One input terminal (+terminal) of the low voltage power supply circuit 14 is connected to the positive electrode of the cell B7 of the second block 22 through the line L2 and the balancer circuit 11. The other input terminal (−terminal) of the low voltage power supply circuit 14 is connected to the negative electrode of the cell B12 of the second block 22 through the line L4 and the balancer circuit 11. The low voltage power supply circuit 14 thus acquires the voltage from both ends of the second block 22 of the assembled battery 2 with a route shown with thick lines in FIG. 5. The low voltage power supply circuit 14 generates a power supply voltage (e.g., 5[V]) of low voltage based on the voltage acquired from the second block 22, and supplies the power supply voltage to the temperature measurement circuit 15, which is a load.

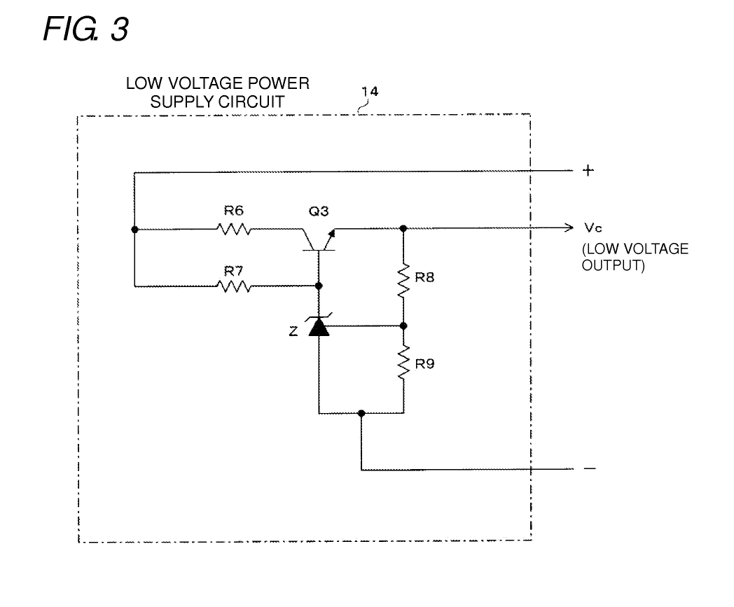

FIG. 3 shows an example of the low voltage power supply circuit 14. The low voltage power supply circuit 14 is a known circuit configured by a switching element Q3, resistors R6 to R9, and a constant voltage element Z. The switching element Q3 includes a bipolar transistor, and the constant voltage element Z includes a shunt reference IC having a function the same as that of the zener diode. The output voltage of the constant voltage element Z and the low voltage Vc determined by the resistor R8 and the resistor R9 are output from the low voltage power supply circuit 14, and supplied to the temperature measurement circuit 15 as a power supply voltage.

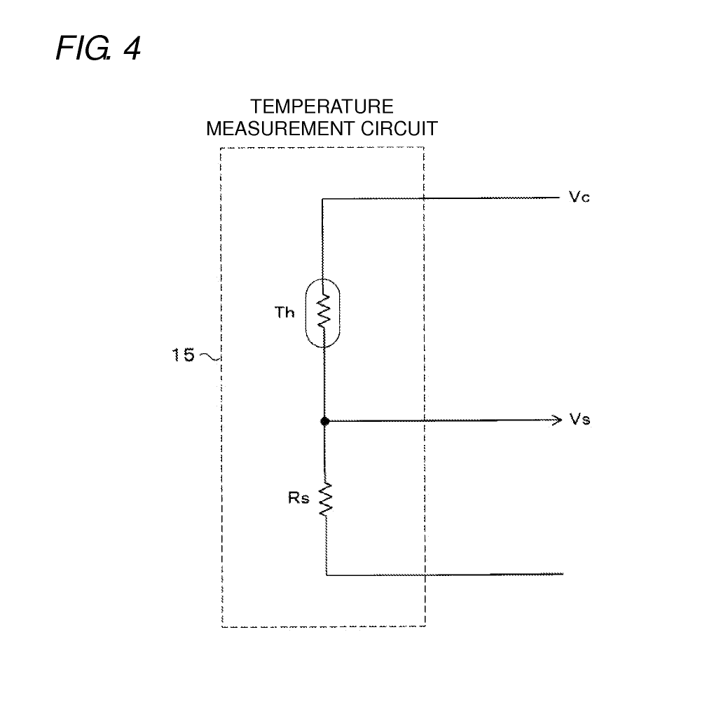

The temperature measurement circuit 15 is a circuit for measuring the temperature of the assembled battery 2. As shown in FIG. 4, the temperature measurement circuit 15 includes a thermistor Th for temperature detection and a shunt resistor Rs for current detection. The thermistor Th has a property in that the resistance value reduces as the temperature becomes higher and the resistance value increases as the temperature becomes lower. The thermistor Th and the resistor Rs are connected in series between the power supplies supplied from the low voltage power supply circuit 14. A voltage Vs of a connecting point of the thermistor Th and the shunt resistor Rs is supplied to the voltage monitoring section 12, as shown in FIG. 1.

The power transmission circuit 16 is a circuit having the characteristics of one or more embodiments of the present invention, and is configured by a transformer 20, the switching element Q1, a resistor R1, and a diode D. The transformer 20 has a primary winding W1 and a secondary winding W2. The switching element Q1 is connected in series to the primary winding W1. The switching element Q1 includes, for example, an FET (Field Effect Transistor), and has the drain connected to the primary winding W1 of the transformer 20, and the source connected to a line L7. The resistor R1 is connected to the gate of the switching element Q1. A control signal (pulse signal) is provided to the gate of the switching element Q1 from the voltage monitoring section 12 via the resistor R1. The switching element Q1 performs the ON/OFF operation in accordance with the control signal. The diode D is a diode for rectification, and is connected in series to the secondary winding W2 of the transformer 20.

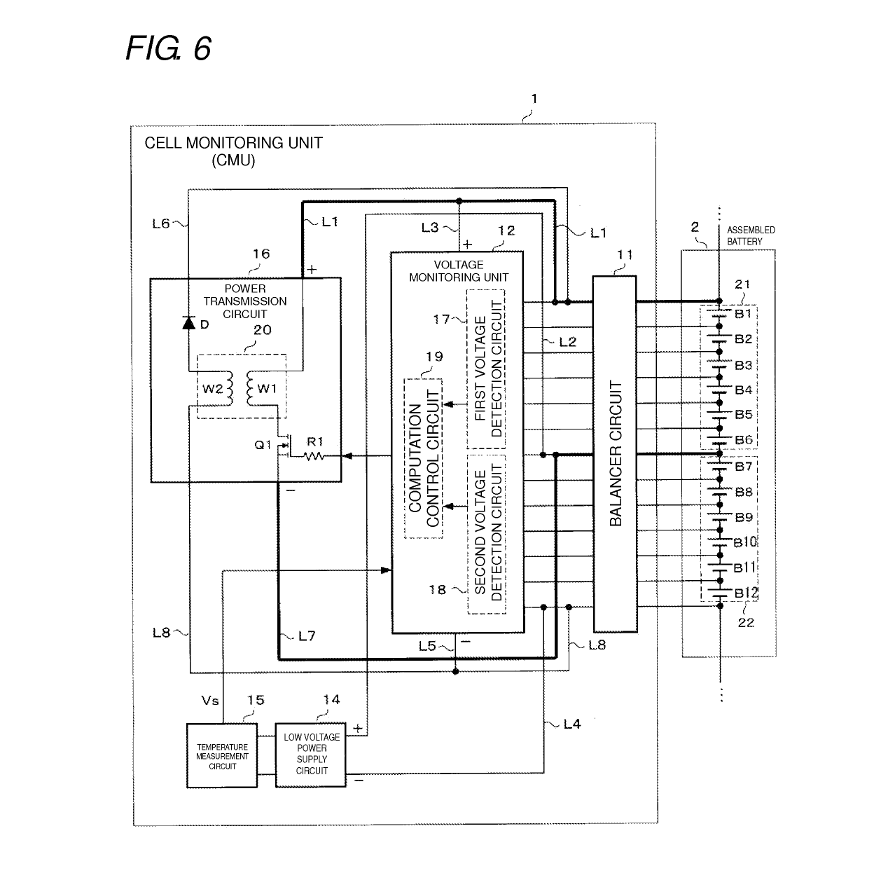

One end of the primary winding W1 of the transformer 20 is connected to the positive electrode of the cell B1 in the first block 21 of the assembled battery 2 through the line L1 and the balancer circuit 11. The other end of the primary winding W1 of the transformer 20 is connected to the negative electrode of the cell B6 in the first block 21 of the assembled battery 2 through the switching element Q1, the line L7, and the balancer circuit 11. The power transmission circuit 16 thus acquires the voltage from both ends of the first block 21 of the assembled battery 2 with a route shown with thick lines in FIG. 6.

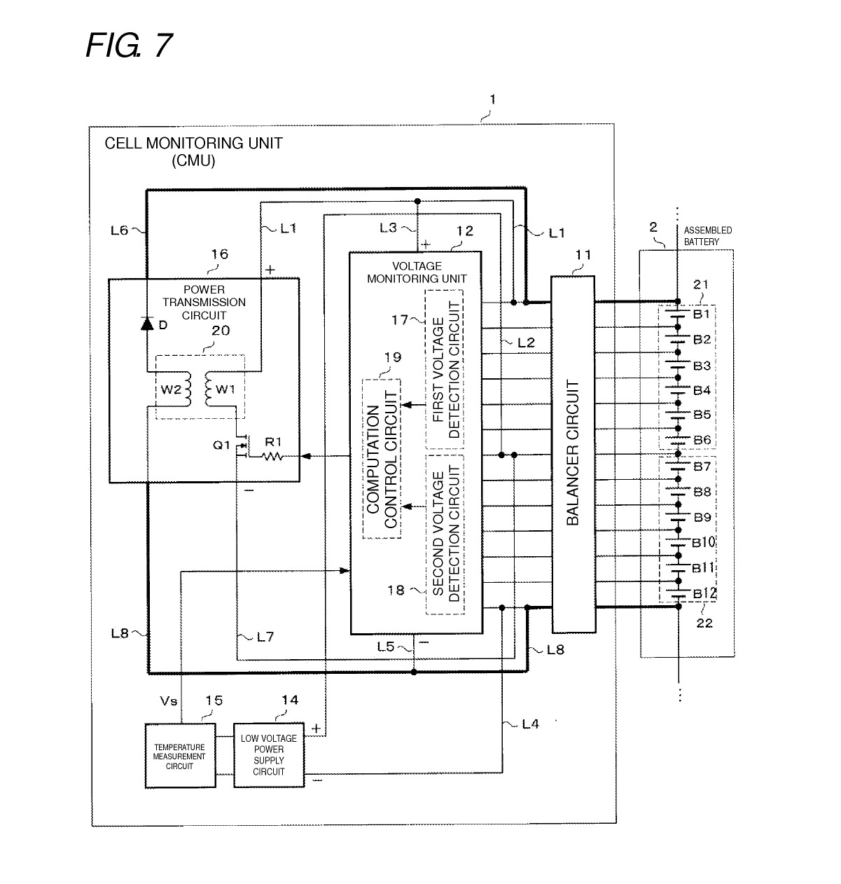

One end of the secondary winding W2 of the transformer 20 is connected to the positive electrode of the cell B1 in the first block 21 of the assembled battery 2 through the diode D, the line L6 and the balancer circuit 11. The other end of the secondary winding W2 of the transformer 20 is connected to the negative electrode of the cell B12 in the second block 22 of the assembled battery 2 through the line L8 and the balancer circuit 11. The power transmission circuit 16 thus supplies power to the assembled battery 2 (first block 21 and second block 22) with a route shown with thick lines in FIG. 7.

The operation of the first embodiment will now be described. In the cell monitoring unit 1, the voltage monitoring section 12 detects each voltage of the cells B1 to B12, and controls the balancer circuit 11 based on the detection result. Specifically, with respect to the cell of high voltage, the voltage monitoring section 12 turns ON the switching element Q2 of the discharging circuits 11a, 11b, 11c, . . . (see FIG. 2) corresponding to the cell of high voltage, and operates the discharging circuit to prioritize the discharging of the cell. With respect to the cell of low voltage, the voltage monitoring section 12 turns OFF the switching element Q2 of the discharging circuits 11a, 11b, 11c, . . . corresponding to the cell of low voltage, and causes the discharging circuit to be in a non-operating state to prioritize the charging of the cell. The voltage lowers in the cell of high voltage by discharging, and the voltage rises in the cell of low voltage by charging, and thus the voltage of cells are uniformized.

When the low voltage power supply circuit 14 acquires the voltage from the entire assembled battery 2, the extent of voltage non-uniformity among the cells B1 to B12 configuring the assembled battery 2 is small, and the process of uniformizing the voltage by the balancer circuit 11 merely needs to be performed. However, when the low voltage power supply circuit 14 acquires the voltage from the second block 22, which is a part of the assembled battery 2 as in the first embodiment, the cells B7 to B12 of the second block 22 are discharged faster than the cells B1 to B6 of the first block 21 unless some kind of measure is taken for the first block 21. As a result, the extent of voltage non-uniformity between the first block 21 and the second block 22 significantly increases. The balancer circuit 11 alone cannot cope with such a case. Thus, in one or more embodiments of the present invention, the uniformization of the cell voltage by the power transmission circuit 16 is carried out in addition to the uniformization of the cell voltage by the balancer circuit 11.

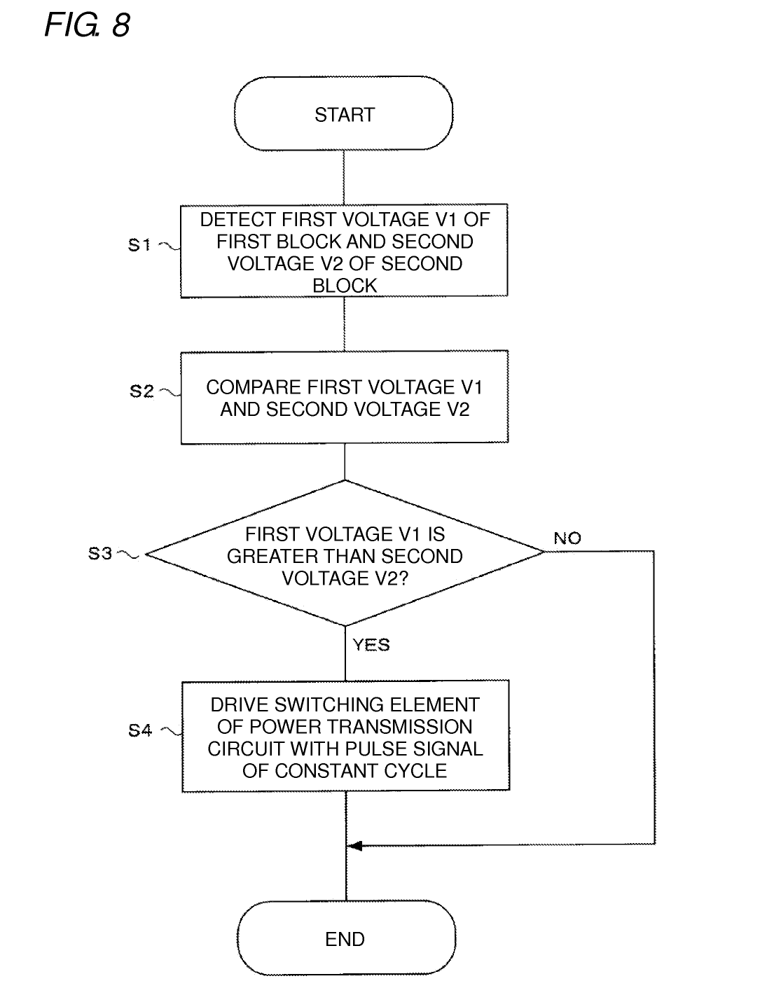

In the power transmission circuit 16, the voltage acquired from both ends of the first block 21 of the assembled battery 2 is transmitted from the primary winding W1 to the secondary winding W2 by the ON/OFF operation of the switching element Q1, and the power output from the secondary winding W2 is supplied to the assembled battery 2 with a route shown in FIG. 7. Hereinafter, the details thereof will be described based on a flowchart of FIG. 8. Each step of FIG. 8 is executed for every constant period by the voltage monitoring section 12.

In step S1, the voltage (first voltage V1) of the first block 21 is detected by the first voltage detection circuit 17, and the voltage (second voltage V2) of the second block 22 is detected by the second voltage detection circuit 18.

In step S2, the first voltage V1 and the second voltage V2 detected in step S1 are compared. In the following step S3, whether or not the first voltage V1 is greater than the second voltage V2 is determined. If the first voltage V1 is greater than the second voltage V2 as a result of the determination (YES in step S3), the process proceeds to step S4.

In step S4, the computation control circuit 19 generates a pulse signal of a constant cycle, which is a control signal, and drives the switching element Q1 of the power transmission circuit 16 according to such signal.

Specifically, the pulse signal generated by the computation control circuit 19 is provided to the gate of the switching element Q1 through the resistor R1. The switching element Q1 performs the ON/OFF operation according to the pulse signal. As a result, the voltage on the primary side of the transformer 20, that is, the voltage acquired from both ends of the first block 21 of the assembled battery 2 is switched, and such voltage is transmitted from the primary winding W1 to the secondary winding W2 of the transformer 20. The power corresponding to the voltage (first voltage V1) of the first block 21 is output from the secondary winding W2. The power is supplied to both ends of the assembled battery 2 with the route shown in FIG. 7. Thus, the assembled battery 2 is re-charged by the power returned from the power transmission circuit 16. In this case, the voltage monitoring section 12 controls the balancer circuit 11 so that the cells B7 to B12 of the second block 22 are preferentially charged. As a result, even if the voltage (second voltage V2) of the second block 22 lowers due to the power consumption in the low voltage power supply circuit 14 and the temperature measurement circuit 15, such voltage drop is compensated by the power returned from the power transmission circuit 16 to the assembled battery 2.

If the first voltage V1 is not greater than the second voltage V2 as a result of the determination in step S3 (NO in step S3), the process is terminated without executing step S4. In this case, the voltage is uniform between the first block 21 and the second block 22 if the first voltage V1 and the second voltage V2 are equal, and thus the power transmission circuit 16 does not need to be driven. If the first voltage V1 is smaller than the second voltage V2, the second voltage V2 of the second block 22 continues to lower due to the power consumption in the low voltage power supply circuit 14 and the temperature measurement circuit 15 and eventually becomes equal to the first voltage V1 of the first block 21, and hence the power transmission circuit 16 does not need to be driven. Therefore, in either case, the switching element Q1 of the power transmission circuit 16 is not driven.

The computation control circuit 19 of the voltage monitoring section 12 also performs the process of calculating the temperature of the assembled battery 2 based on the voltage Vs acquired from the temperature measurement circuit 15. The calculated temperature is transmitted from the voltage monitoring section 12 to the higher-order device (not shown). The higher-order device controls the charging device (not shown) when the value of the temperature is abnormal, and performs processes such as stopping the charging to the assembled battery 2, and the like.

According to the first embodiment described above, the low voltage power supply circuit 14 acquires the voltage from the second block 22, which is a part of the assembled battery 2, and thus the input voltage of the low voltage power supply circuit 14 is a low voltage compared to the voltage of the entire assembled battery 2. Thus, a circuit such as the DC-DC converter for converting the high voltage to the low voltage is unnecessary, and the configuration of the low voltage power supply circuit 14 is simplified.

For the first block 21 in which the voltage for power supply is not acquired, the power transmission circuit 16 for acquiring the voltage from the relevant block is arranged so that the power corresponding to the acquired voltage is returned to the assembled battery 2. Thus, the power of the second block 22 consumed by the low voltage power supply circuit 14 and the temperature measurement circuit 15 can be compensated by the power from the power transmission circuit 16. The voltage of each cell configuring the assembled battery 2 is thereby equalized, and the voltage can be suppressed from becoming non-uniform among the cells.

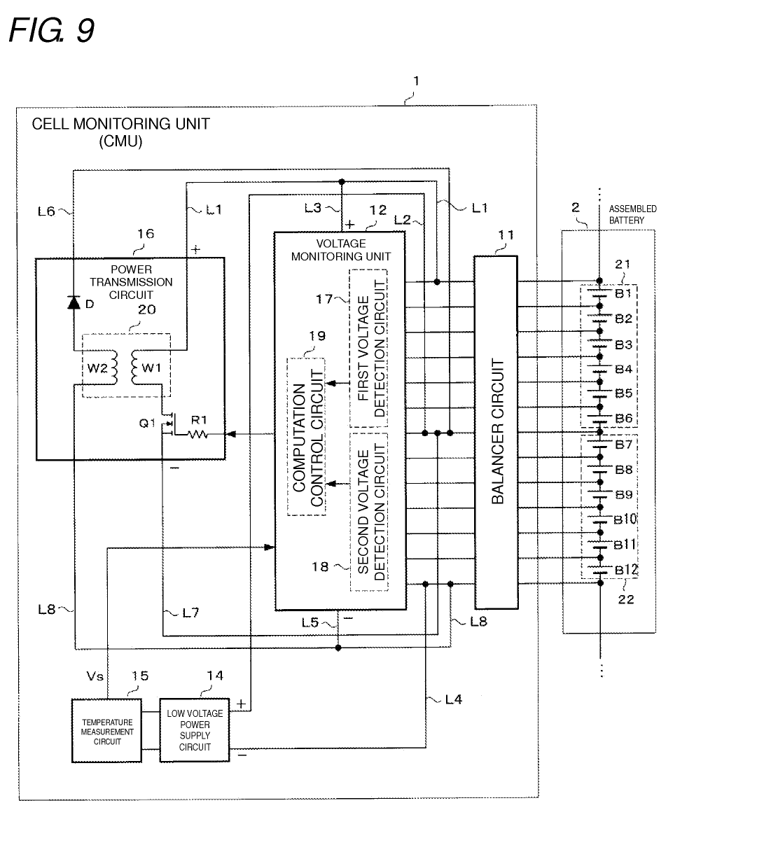

FIG. 9 shows a variant of the first embodiment. In FIG. 9, the same reference numerals as FIG. 1 are denoted on the portions same as or corresponding to the portions in FIG. 1.

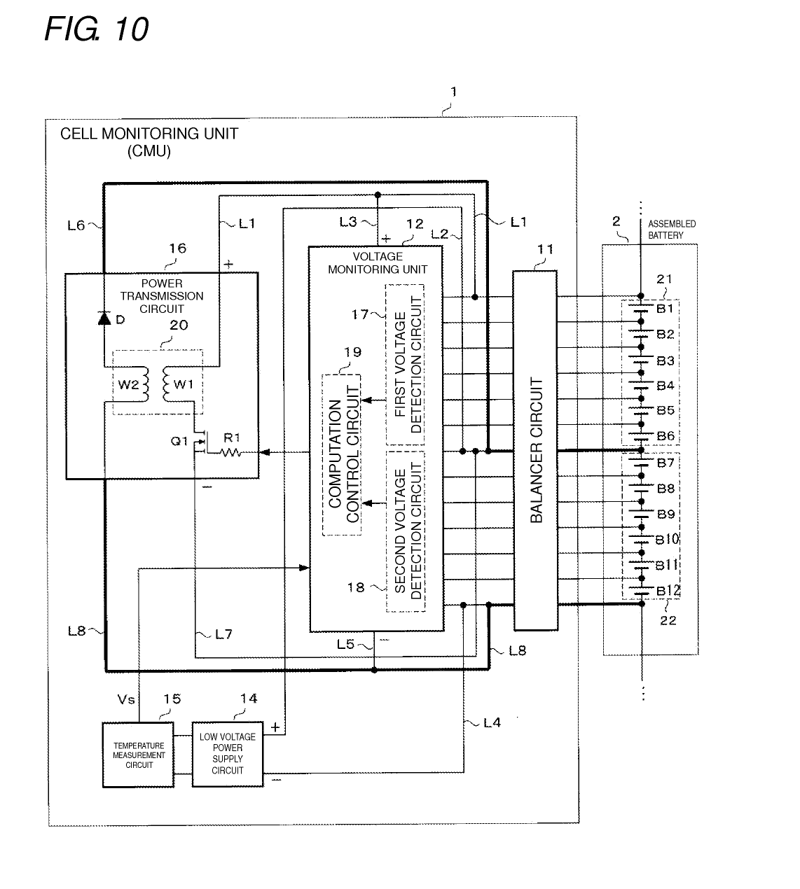

In FIG. 1, one end of the line L6 is connected to the positive electrode of the cell B1 in the first block 21 of the assembled battery 2 through the balancer circuit 11, and the power output from the power transmission circuit 16 is returned to the entire assembled battery 2. On the contrary, in FIG. 9, one end of the line L6 is connected to the positive electrode of the cell B7 in the second block 22 of the assembled battery 2 through the balancer circuit 11. The power transmission circuit 16 thus supplies power to the second block 22, which is a part of the assembled battery 2, with a route shown with thick lines in FIG. 10. Other aspects are similar to FIG. 1.

In this manner as well, the power of the second block 22 consumed by the low voltage power supply circuit 14 and the temperature measurement circuit 15 can be compensated, and the voltage can be suppressed from becoming non-uniform among the cells. Furthermore, the power output from the power transmission circuit 16 is returned only to the second block 22 in which the voltage lowered by power consumption, so that voltage equalization of each cell configuring the assembled battery 2 can be efficiently carried out.

### Second Embodiment

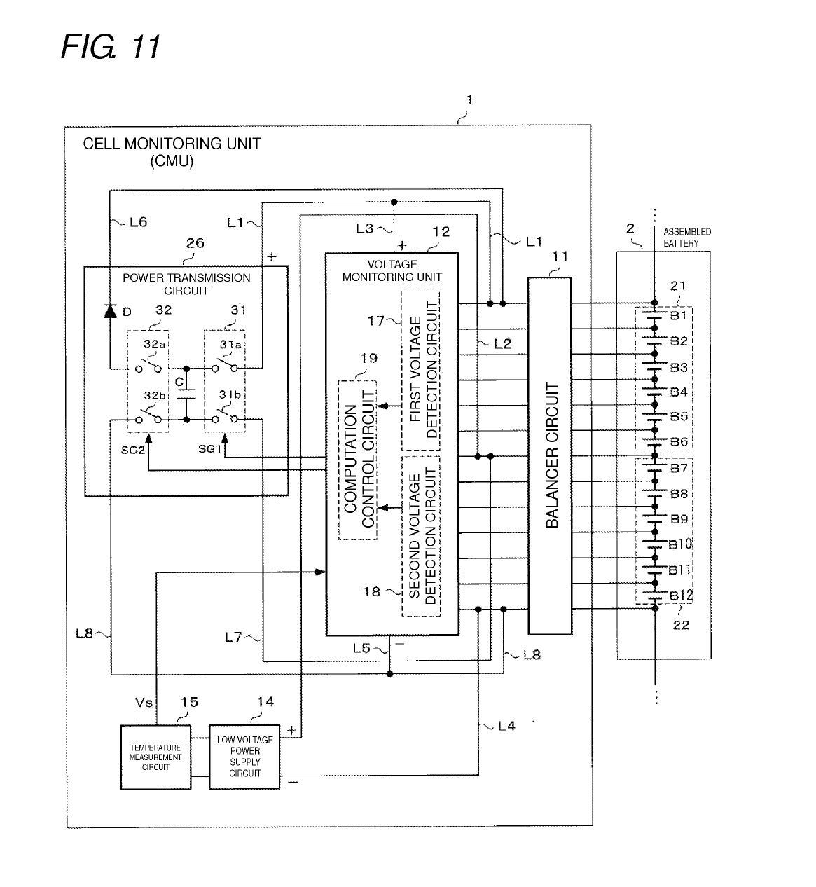

A second embodiment of the present invention will now be described with reference to FIG. 11. In FIG. 11, the configuration of a power transmission circuit 26 differs from that of the power transmission circuit 16 of FIG. 1. The power transmission circuit 26 includes a capacitor C, a first switch 31 arranged on the input side of the capacitor C, and a second switch 32 arranged on the output side of the capacitor C. The first switch 31 includes two switches 31a, 31b that are switched in cooperation, and the second switch 32 also includes two switches 32a, 32b that are switched in cooperation. The first switch 31 is switched ON or OFF by a first control signal SG1 output from the voltage monitoring section 12. The second switch 32 is switched ON or OFF by a second control signal SG2 output from the voltage monitoring section 12.

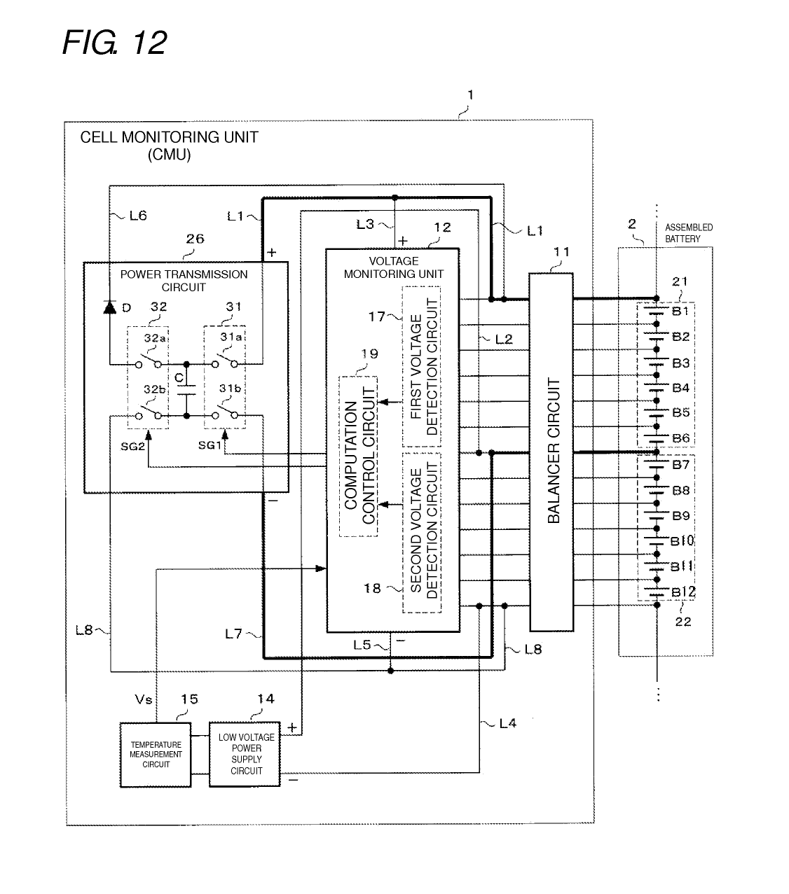

One end of one switch 31a of the first switch 31 is connected to the positive electrode of the cell B1 in the first block 21 of the assembled battery 2 through the line L1 and the balancer circuit 11. The other end of the switch 31a is connected to one end of the capacitor C. One end of the other switch 31b of the first switch 31 is connected to the negative electrode of the cell B6 in the first block 21 of the assembled battery 2 through the line L7 and the balancer circuit 11. The other end of the switch 31b is connected to the other end of the capacitor C. The power transmission circuit 26 thus acquires the voltage from both ends of the first block 21 of the assembled battery 2 with a route shown with thick lines in FIG. 12.

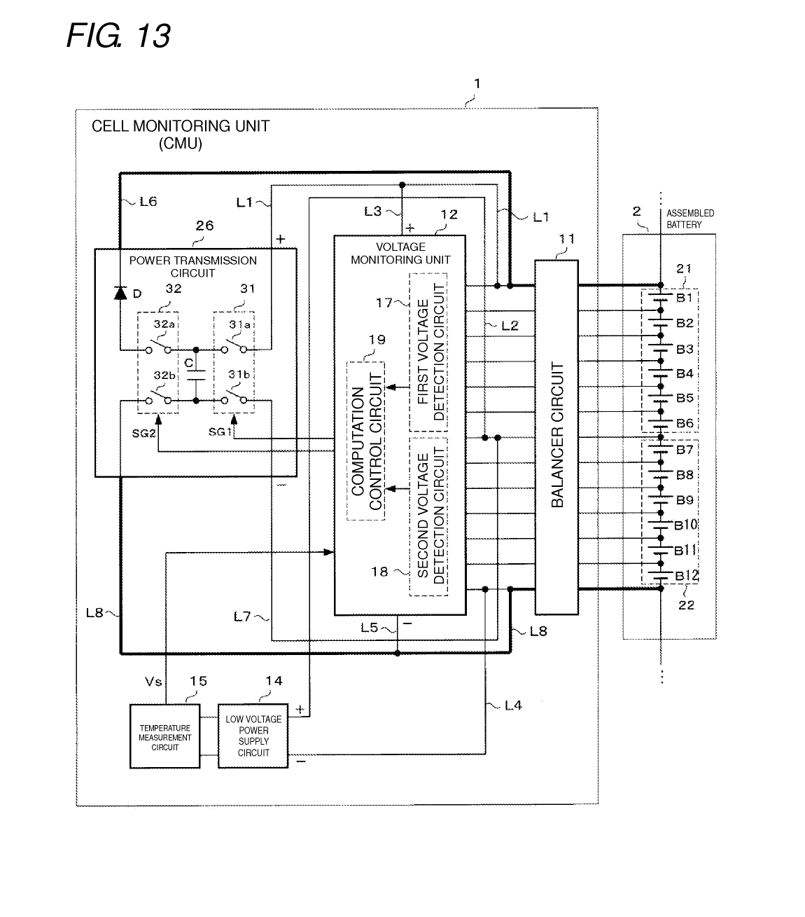

One end of one switch 32a of the second switch 32 is connected to the positive electrode of the cell B1 in the first block 21 of the assembled battery 2 through the diode D, the line L6 and the balancer circuit 11. The other end of the switch 32a is connected to one end of the capacitor C. One end of the other switch 32b of the second switch 32 is connected to the negative electrode of the cell B12 in the second block 22 of the assembled battery 2 through the line L8 and the balancer circuit 11. The other end of the switch 32b is connected to the other end of the capacitor C. The power transmission circuit 26 thus supplies power to the assembled battery 2 (first block 21 and second block 22) with a route shown with thick lines in FIG. 13.

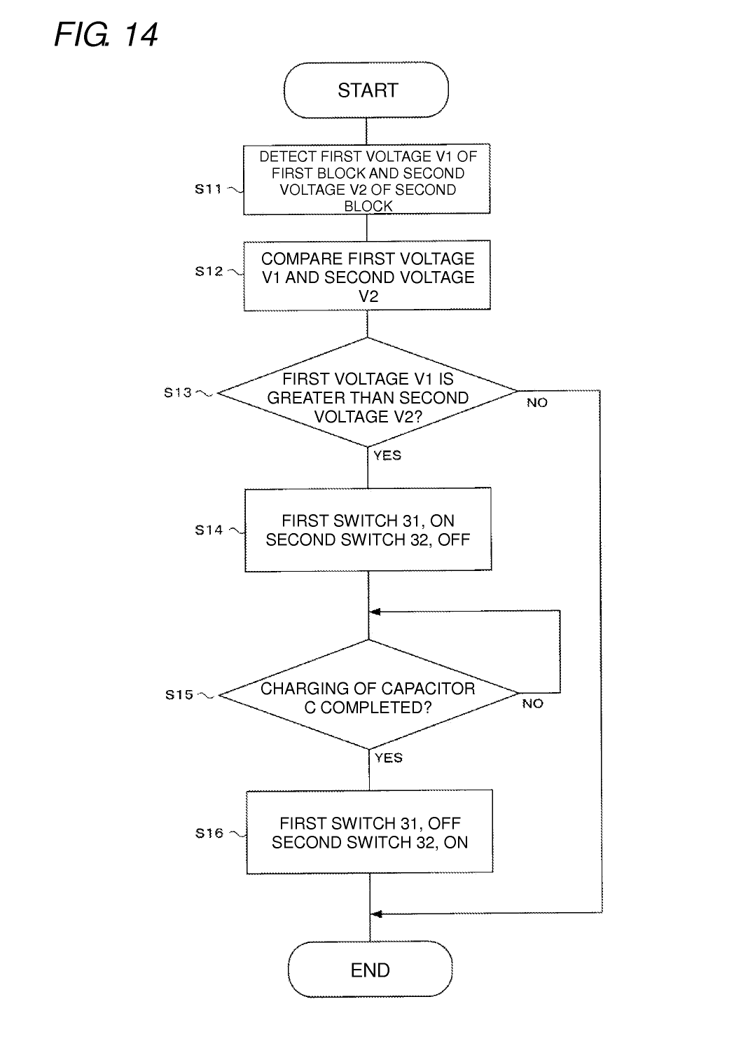

The operation of the second embodiment will now be described. The operation of the balancer circuit 11 is the same as that of the first embodiment, and thus the description will be omitted. Hereinafter, the uniformity of the voltage by the power transmission circuit 26 will be described based on the flowchart of FIG. 14. Each step of FIG. 14 is executed for every constant period by the voltage monitoring section 12.

In step S11, the voltage (first voltage V1) of the first block 21 is detected by the first voltage detection circuit 17, and the voltage (second voltage V2) of the second block 22 is detected by the second voltage detection circuit 18.

In step S12, the first voltage V1 and the second voltage V2 detected in step S11 are compared. In the following step S13, whether or not the first voltage V1 is greater than the second voltage V2 is determined. If the first voltage V1 is greater than the second voltage V2 as a result of the determination (YES in step S13), the process proceeds to step S14.

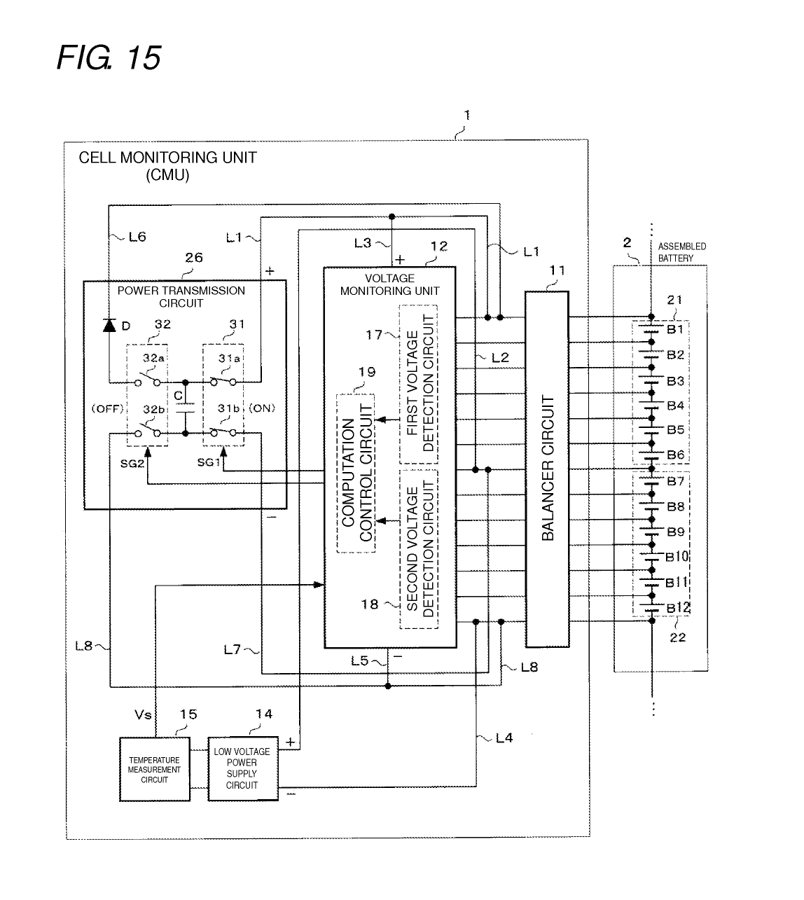

As shown in FIG. 15, in step S14, the first switch 31 is turned ON by the first control signal SG1 generated by the computation control circuit 19, and the second switch 32 is turned OFF by the second control signal SG2 generated by the computation control circuit 19. When the first switch 31 is turned ON, the capacitor C is charged through the first switch 31 by the voltage acquired from the first block 21 of the assembled battery 2.

In step S15, whether or not the charging of the capacitor C is completed is determined. This determination is carried out, for example, by measuring the time from the start of charging with a timer (not shown), and monitoring whether or not the measured time reached the time necessary for the completion of charging. When the charging of the capacitor C is completed (YES in step S15) after a given time, the process proceeds to step S16.

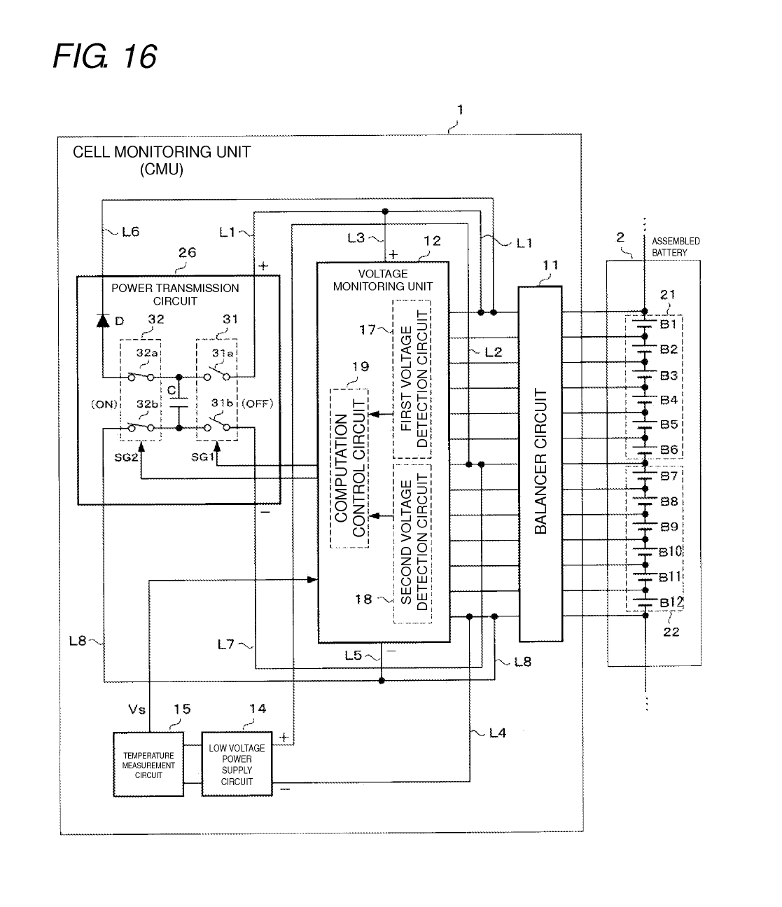

As shown in FIG. 16, in step S16, the first switch 31 is turned OFF by the first control signal SG1 generated by the computation control circuit 19, and the second switch 32 is turned ON by the second control signal SG2 generated by the computation control circuit 19. When the second switch 32 is turned ON, the power of the charged capacitor C, that is, the power corresponding to the voltage (first voltage V1) of the first block 21 is output from the power transmission circuit 26. The power is supplied to both ends of the assembled battery 2 with the route shown in FIG. 13. Thus, the assembled battery 2 is re-charged by the power returned from the power transmission circuit 26. In this case, the voltage monitoring section 12 controls the balancer circuit 11 so that the cells B7 to B12 of the second block 22 are preferentially charged. As a result, even if the voltage (second voltage V2) of the second block 22 lowers due to the power consumption in the low voltage power supply circuit 14 and the temperature measurement circuit 15, such voltage drop is compensated by the power returned from the power transmission circuit 26 to the assembled battery 2.

If the first voltage V1 is not greater than the second voltage V2 as a result of the determination in step S13 (NO in step S13), the process is terminated without executing steps S14 to S16. In this case, the voltage is uniform between the first block 21 and the second block 22 if the first voltage V1 and the second voltage V2 are equal, and thus the power transmission circuit 26 does not need to be driven. If the first voltage V1 is smaller than the second voltage V2, the second voltage V2 of the second block 22 continues to lower due to the power consumption in the low voltage power supply circuit 14 and the temperature measurement circuit 15 and eventually becomes equal to the first voltage V1 of the first block 21, and hence the power transmission circuit 26 does not need to be driven. Therefore, in either case, the first switch 31 and the second switch 32 of the power transmission circuit 26 are maintained in the OFF state.

According to the second embodiment described above, the low voltage power supply circuit 14 acquires the voltage from the second block 22, which is a part of the assembled battery 2, and thus the input voltage of the low voltage power supply circuit 14 is a low voltage compared to the voltage of the entire assembled battery 2, similar to the first embodiment. Thus, a circuit such as the DC-DC converter for converting the high voltage to the low voltage is unnecessary, and the configuration of the low voltage power supply circuit 14 is simplified.

For the first block 21 in which the voltage for power supply is not acquired, the power transmission circuit 26 for acquiring the voltage from the relevant block is arranged so that the power corresponding to the acquired voltage is returned to the assembled battery 2. Thus, the power of the second block 22 consumed by the low voltage power supply circuit 14 and the temperature measurement circuit 15 can be compensated by the power from the power transmission circuit 26. The voltage of each cell configuring the assembled battery 2 is thereby equalized, and the voltage can be suppressed from becoming non-uniform among the cells.

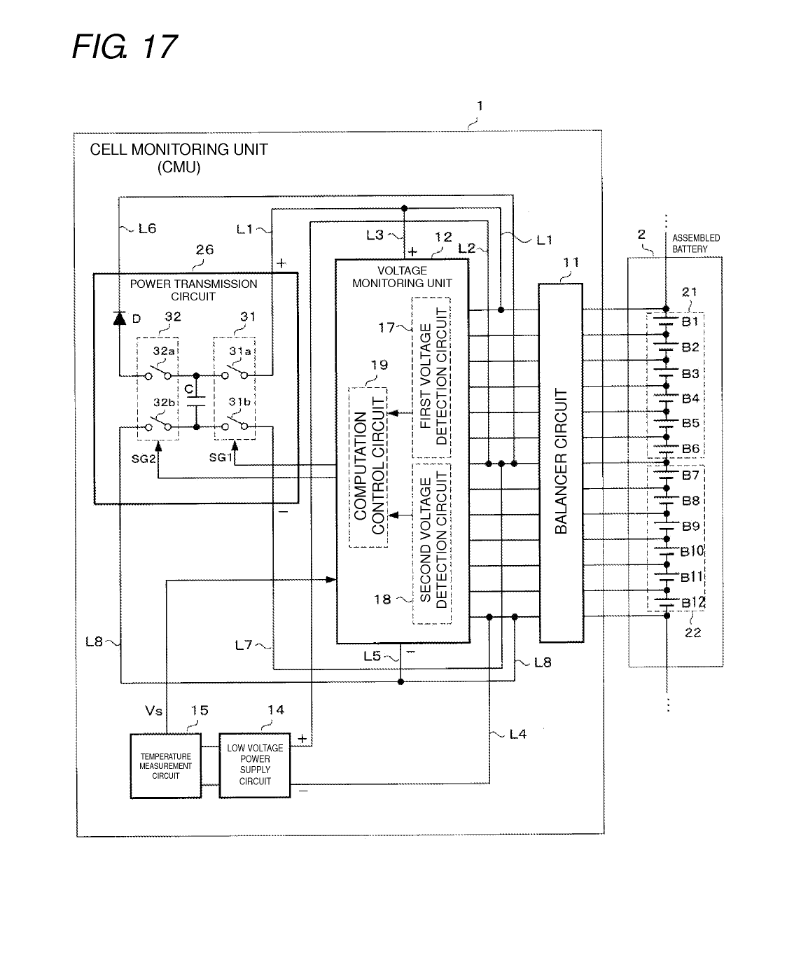

FIG. 17 shows a variant of the second embodiment. In FIG. 17, the same reference numerals as FIG. 11 are denoted on the portions same as or corresponding to the portions in FIG. 11.

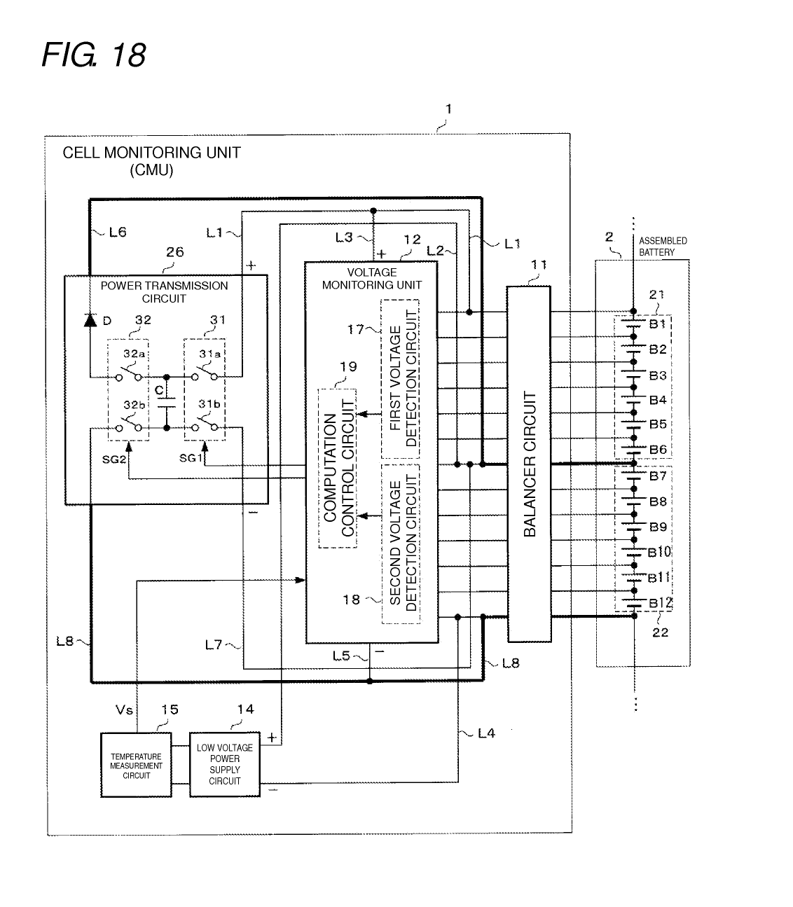

In FIG. 11, one end of the line L6 is connected to the positive electrode of the cell B1 in the first block 21 of the assembled battery 2 through the balancer circuit 11, and the power output from the power transmission circuit 26 is returned to the entire assembled battery 2. On the contrary, in FIG. 17, one end of the line L6 is connected to the positive electrode of the cell B7 in the second block 22 of the assembled battery 2 through the balancer circuit 11. The power transmission circuit 26 thus supplies power to the second block 22, which is a part of the assembled battery 2, with a route shown with thick lines in FIG. 18. Other aspects are similar to FIG. 11.

In this manner as well, the power of the second block 22 consumed by the low voltage power supply circuit 14 and the temperature measurement circuit 15 can be compensated, and the voltage can be suppressed from becoming non-uniform among the cells. Furthermore, the power output from the power transmission circuit 26 is returned only to the second block 22 in which the voltage lowered by power consumption, so that voltage equalization of each cell configuring the assembled battery 2 can be efficiently carried out.

Various embodiments other than those described above can be adopted within a scope of the present invention. For example, in one or more of the embodiments described above, the number of cells of the first block 21 of the assembled battery 2 and the number of cells of the second block 22 are the same (six for both), but the number of cells of each block 21, 22 may be different. The number of cells of each block 21, 22 is not limited to plural, and may be singular (one).

In the first embodiment described above, the FET is used for the switching element Q1 of the power transmission circuit 16, but a transistor, a relay, and the like may be used in place of the FET.

In one or more of the embodiments described above, the temperature measurement circuit 15 has been described by way of example as the load of the low voltage power supply circuit 14, but the load of the low voltage power supply circuit 14 may be a load (e.g., communication IC) other than the temperature measurement circuit.

Furthermore, above, an example in which one or more embodiments of the present invention is applied to the assembled battery mounted on an electric automobile has been described, but one or more embodiments of the present invention may also be applied to the assembled battery used for applications other than the electric automobile.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A voltage monitoring apparatus of an assembled battery comprising:
a voltage monitoring section that monitors each voltage of the assembled battery formed by a plurality of cells; and
a power supply circuit that acquires a voltage from the assembled battery to generate a power supply voltage of low voltage, and supplies the power supply voltage to a load,
wherein the assembled battery is configured by a series circuit of a first block, which includes a plurality of cells or a singular cell, and a second block, which is configured by a plurality of cells or a singular cell,
wherein the power supply circuit acquires a voltage from both ends of the second block, and
wherein the voltage monitoring apparatus further comprises:
a power transmission circuit that acquires a voltage from both ends of the first block and supplies a power corresponding to the acquired voltage to at least the second block.

2. The voltage monitoring apparatus according to claim 1,
wherein the power transmission circuit comprises:
a transformer with a primary winding and a secondary winding, and
a switching element connected in series with the primary winding,
wherein the power transmission circuit transmits the voltage acquired from both ends of the first block from the primary winding to the secondary winding by an ON/OFF operation of the switching element, and
wherein the power transmission circuit supplies a power output from the secondary winding to at least the second block.

3. The voltage monitoring apparatus according to claim 2,
wherein the voltage monitoring section comprises:
a first voltage detection circuit that detects a first voltage, which is the voltage of both ends of the first block,
a second voltage detection circuit that detects a second voltage, which is the voltage of both ends of the second block, and
a computation control circuit that generates a control signal for controlling the switching element based on a comparison result of the first voltage and the second voltage.

4. The voltage monitoring apparatus according to claim 3,
wherein the voltage monitoring section determines whether the first voltage is greater than the second voltage,
wherein the voltage monitoring section performs the ON/OFF operation of the switching element according to the control signal if the first voltage is greater than the second voltage, and
wherein the voltage monitoring section does not perform the ON/OFF operation of the switching element if the first voltage is not greater than the second voltage.

5. The voltage monitoring apparatus according to claim 1,
wherein the power transmission circuit includes a capacitor, a first switch arranged on an input side of the capacitor, and a second switch arranged on an output side of the capacitor,
wherein the power transmission circuit charges the capacitor with the voltage acquired from both ends of the first block through the first switch when the second switch is turned OFF and the first switch is turned ON,
wherein the power transmission circuit outputs a power of the charged capacitor through the second switch when the first switch is turned OFF and the second switch is turned ON thereafter, and
wherein the power transmission circuit supplies the power output from the capacitor to at least the second block.

6. The voltage monitoring apparatus according to claim 5,
wherein the voltage monitoring section comprises:
a first voltage detection circuit that detects a first voltage, which is the voltage of both ends of the first block,
a second voltage detection circuit that detects a second voltage, which is the voltage of both ends of the second block, and
a computation control circuit that generates a first control signal for controlling the first switch and a second control signal for controlling the second switch based on a comparison result of the first voltage and the second voltage.

7. The voltage monitoring apparatus according to claim 6,
wherein the voltage monitoring section determines whether the first voltage is greater than the second voltage,
wherein the voltage monitoring section turns ON the first switch and then turns OFF the first switch after a given time according to the first control signal, and turns OFF the second switch and then turn ON the second switch after a given time according to the second control signal if the first voltage is greater than the second voltage, and
wherein the voltage monitoring section maintains the first switch and the second switch in an OFF state if the first voltage is not greater than the second voltage.

8. The voltage monitoring apparatus according to claim 1,
wherein the power output from the power transmission circuit is supplied to the entire assembled battery.

9. The voltage monitoring apparatus according to claim 2,
wherein the power output from the power transmission circuit is supplied to the entire assembled battery.

10. The voltage monitoring apparatus according to claim 3,
wherein the power output from the power transmission circuit is supplied to the entire assembled battery.

11. The voltage monitoring apparatus according to claim 4,
wherein the power output from the power transmission circuit is supplied to the entire assembled battery.

12. The voltage monitoring apparatus according to claim 5,
wherein the power output from the power transmission circuit is supplied to the entire assembled battery.

13. The voltage monitoring apparatus according to claim 6,
wherein the power output from the power transmission circuit is supplied to the entire assembled battery.

14. The voltage monitoring apparatus according to claim 7,
wherein the power output from the power transmission circuit is supplied to the entire assembled battery.
